(19) United States
(12) Patent Application Publication
(10) Pub. No.: US 2007/0018774 A1
(43) Pub. Date: Jan. 25, 2007

(54) Reactive fuse element with exothermic reactive material

(76) Inventors: Gordon T. Dietsch, Park Ridge, IL (US); Timothy E. Pachla, Berwyn, IL (US); Stephen J. Whitney, Lake Zurich, IL (US); William G. Rodseth, Antioch, IL (US)

Correspondence Address: Bell, Boyd & Lloyd LLC, P.O. Box 1135, Chicago, IL, 60690-1135, US

(21) Appl. No.: 11/186,130

(22) Filed: Jul. 20, 2005

(51) Int. Cl. H01H 85/04

(52) U.S. Cl. 337/159

(57) ABSTRACT

Reactive fuses that contain reactive fuse elements for use in electrical circuits and other applications are provided. In various exemplary embodiments reactive materials and reactive foils are employed to provide a focused, localized heat source which can by used to open or sever a fuse element, or precisely join one or more metallic components. In particular, reactive material can be utilized to open a fuse element in response to the heat generated by a sustained overload current. Alternatively, reactive material may be utilized in the construction of a reactive fuse to join, for example, metallic components to a base fuse element or fuse cap.

### BACKGROUND

This patent generally relates to fuse elements, and more specifically to the time-current opening characteristics of a fuse element.

It is well understood that by using an electrical fuse having a metallic fuse element, electrical circuits and components can be protected against overload currents and short circuits. In operation, the electrical fuse and the included fuse element are arranged in electrical communication within the electrical circuit. When the electrical circuit experiences a fault current, the high current flowing through the electrical fuse generates heat which, in turn, causes the fuse element to melt and open the circuit.

To control the time-current opening characteristic of the electrical fuse, it is known to incorporate a diffusion metal having a lower melting point such as, for example, tin (Sn) or tin-lead (SnPb) with the base fuse element metal. When subjected to an overload current condition, the lower melting point metal diffuses into the base fuse element metal creating an alloy having an overall lower melting point and increased resistance, thereby facilitating melting or opening of the fuse element. Similarly, by increasing the cross sectional dimensions of the alloy fuse element the time required to open, i.e., melt, the fuse element is increased which, in turn, increases the overall opening time of the electrical fuse during an overload current condition. Moreover, the increased physical dimension of the fuse element reduces the fuse's sensitivity to short term transient current surges or pulses.

While the above description discloses a known method of fuse design and manufacture, a need exists for a simpler, more efficient and/or more flexible method of controlling an overload current.

### SUMMARY

Illustrative examples of reactive fuses and fuse elements are discussed below in the Detailed Description section of this specification. The examples include

various embodiments and configurations of reactive material, such as reactive foils, arranged to cooperate with reactive fuses and fuse elements.

In particular, one example of a reactive fuse includes a substrate having a top surface, a first end and a second end arranged distal to the first end. The reactive fuse may further contain a first conductor positioned adjacent to the first end along the top surface, and a second conductor positioned adjacent to second end along the top surface such that the first and second conductors are spaced apart along the top surface. A reactive material having a stable state and an exothermic state can be affixed or joined to the top surface of the substrate to electrically couple the first and second conductors.

The substrate can be an insulative substrate manufactured from a material selected from the group consisting of flame retardant woven glass reinforced epoxy laminates, non-woven glass laminates, ceramics, glass, polytetrafluoroethylene, microfiber glass substrates, thermoset plastics, polyimide materials or any combination of these materials or other suitable materials.

The reactive material is configured to produce a self-propagating exothermic reaction in response to an energy input. The reactive material may be a nanofilm and constructed of alternating layers of nickel and aluminum. The energy input can come for a wide variety sources such as, for example, the heat generated by a current overload, a spark or short circuit, a flame, a heated filament, focused radio frequency radiation or light amplification by stimulated emission of radiation.

The reactive fuse can further include a fuse link positioned adjacent to the substrate and the reactive material such that the fuse link is electrically coupled to the first and second conductors.

In one embodiment, the reactive material is a reactive foil aligned adjacent to the substrate, and the substrate is a flexible insulative substrate such that the reactive foil and the flexible insulative substrate are bendable to align the first and second conductors in an overlapping arrangement.

In another embodiment, the fuse element used within a reactive fuse includes a fuse link and a reactive material carried by the fuse link. The reactive material of this exemplary embodiment includes a plurality of nano-layers configured to produce a self-propagating exothermic reaction in response to an energy input. The reactive material may be constructed of a plurality of alternating layers of nickel and aluminum, and may cooperate with the fuse link to define a fusing area.

Other embodiments may include a fuse link that is a cylindrical fuse link. The cylindrical fuse link, in turn, includes an exterior surface arranged to carry the reactive material. The reactive material may spirally engage the exterior surface of the fuse link.

One exemplary method of forming a reactive fuse includes providing an electrically conductive fuse link that has a bonding surface and aligning a reactive material adjacent to the bonding surface of the fuse link, the reactive material typically includes a plurality of nano-layers configured to produce a self-propagating exothermic reaction in response to an energy input. Establishing a fusing area between the reactive material and the fuse link, and securing the reactive material to the bonding surface and the fusing area to define a reactive fuse element.

In one exemplary embodiment the method includes a conductive fuse link formed as a cylindrical fuse link having a hollow interior such that the reactive material is carried within the hollow interior of the fuse link. In another exemplary embodiment, the fusing area encompasses a first end of the fuse link and a second end of the fuse link wherein the second end of the fuse link formed distal to the first end.

The reactive material can be secured using a silicone cover affixed adjacent to the bonding surface or using an adhesive positioned between the fuse link and the reactive material.

Additional features and advantages of the present invention are described in, and will be apparent from, the following Detailed Description and the figures.

### BRIEF DESCRIPTION OF THE FIGURES

FIGS. 1A and 1B are perspective views of one embodiment of an electrical fuse that includes a fuse element incorporating a fuse link and a reactive material.

FIG. 2 is an enlarged perspective view of one embodiment of a generally planar fuse element that includes a fuse link and a reactive material.

FIG. 3 is a perspective view of one embodiment of a generally cylindrical fuse element.

FIG. 4 is a perspective view of another embodiment of a generally cylindrical fuse element.

FIG. 5 is a plan view of one embodiment of a generally planar fuse element that includes a fault area.

FIGS. 6A, 6B and 6C are various perspective views of one embodiment of a flexible fuse element showing stacked, assembled and rolled views, respectively.

FIGS. 7A and 7B are top views of two embodiments of an enclosed fuse that includes a flexible fuse element.

FIG. 8 is a side view of another embodiment of an enclosed fuse element that includes a flexible fuse element.

FIG. 9 is an enlarged side view of one embodiment of a chip package fuse that includes a reactive material.

FIG. 10 is a side view of one embodiment of a reactive material employed to join two or more elements of an electric fuse.

FIG. 11A, 11B and 11C are a top and side views, respectively, of a reactive material employed to join a metallic component to a fuse element.

FIG. 12 is a sectional side view of a cylindrical electrical fuse that includes a reactive material.

### DETAILED DESCRIPTION

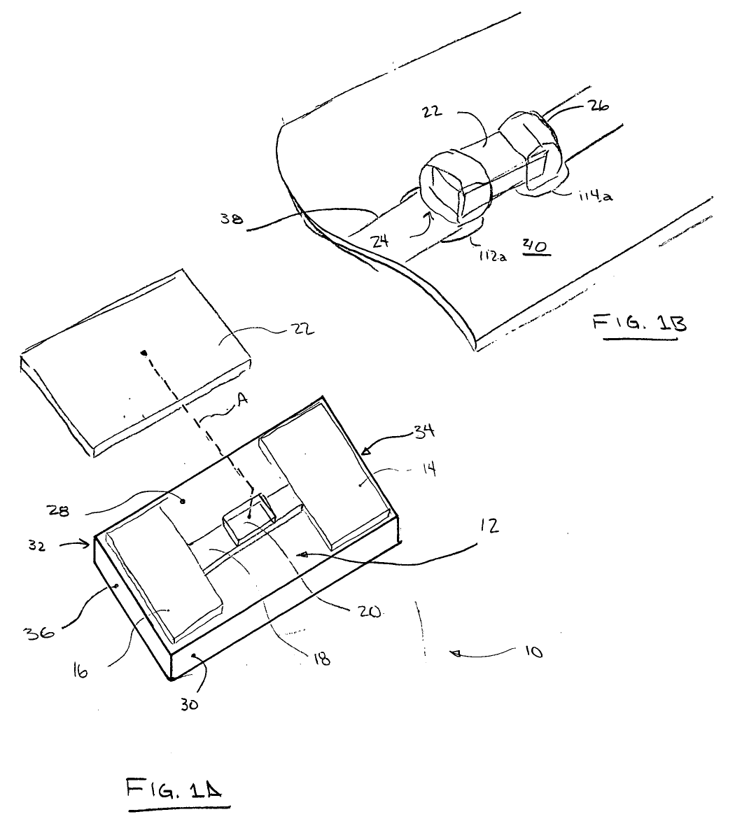

Referring now to the drawings, FIGS. 1A and 1B illustrate an embodiment of an electrical fuse. In particular, the illustrated embodiment of the electrical fuse is manufactured as a surface mount device (SMD) generally indicated by the reference numeral 10. The electrical fuse 10 includes (a) substrate 12 arranged to support (b) first and second termination pads 14, 16 and (c) a fuse link 18 having (d) a reactive material 20, which electrically connects to the first and second termination pads 14, 16. The electrical fuse 10 may further include (e) a cover 22 arranged to protect the fuse link 18, the reactive material 20 and the first and second termination pads 14, 16, as indicated by the assembly line A, and (f) electrically conductive terminations 24, 26 formed at opposing ends of the electrical fuse 10 and substrate 12 to facilitate attachment to a circuit pathway 38 formed on a printed circuit board 40 (PCB) or any other suitable substrate (see FIG. 1B), such as a semi-rigid or flexible substrate.

The substrate 12 can be manufactured from a variety of insulative materials such as, for example, flame retardant woven glass reinforced epoxy (FR4) PCB laminates, other non-woven glass laminates, ceramics, glass, polytetrafluoroethylene (PTFE), microfiber glass substrates, thermoset plastics, polyimides, etc. The substrate 12 of this exemplary embodiment is a substantially rectangular substrate having a top surface 28, a pair of lateral sides 30 and 32 a first end 34 and a second end 36 defined distal to the first end 34. The top surface 28 of the substrate 12 supports and carries the first and second termination pads 14, 16 adjacent to the corresponding first and second ends 34, 36.

The first and second termination pads 14, 16 can be deposited or formed on the top surface 28 using any known manufacturing techniques such as, for example, lamination, photoimaging, dry film processing, sputtering, screen printing and electroplating. The first and second termination pads 14, 16 are typically formed from an electrically conductive material like copper, a copper nickel (CuNi) alloy, silver plated brass, tin-lead (SnPb) solder, lead free (Pb-free) solder, gold (Au), silver (Ag), zinc (Zn) or other combinations of these materials. The materials and alloys comprising the first and second termination pads 14, 16 can be deposited or placed on the top surface 28 of the substrate 12 in a layered manner via multiple step process or alternatively can be directly deposited in a single operation.

The fuse link 18 provides a physical connection between the first and second termination pads 14, 16 to define an electrical pathway therebetween. The fuse link 18 in this exemplary embodiment may be formed from a variety of electrically conductive materials such as those discussed above or Cu, SnPb solder and any other suitably conductive material. The material of the fuse link 18 is typically selected to open or break electrical contact in response to the heat generated as a result of an overcurrent, a surge or spike in electrical current and/or a short circuit condition.

The reactive material 20, as shown in FIG. 1A, partially covers the fuse link 18. However, it will be understood that the reactive material 20 can completely cover or enclose the fuse link 18. The reactive material 20 is a thermal interface material such as, for example, a NanoFoil® produced by Reactive Nano Technologies, Inc. (RNT) of Hunt Valley, Md. Thermal interface materials are typically manufactured as foil sheets or in predefined, application specific geometries to provide a controlled localized heat source. Thermal interface materials such as NanoFoil® typically include a plurality of alternating layers or nano-layers each around a 100 nanometers (nm) thick.

The alternating nano-layers of reactive material 20 may initially be any one or more of a variety of materials, such as nickel (Ni) and aluminum (Al) that react in response to an energy source to create a NiAl reaction product. Other initial reactants and their resulting reaction products may include: titanium (Ti) and boron (B), and titanium boride (TiB2); zirconium (Zr) and boron, and zirconium boride (ZrB2); hafnium (Hf) and boron, and hafnium boride (HfB2); Ti and carbon (C), and titanium carbide (TiC); Zr and carbon, and zirconium carbide (ZrC), Hf and carbon, and hafnium carbide (HfC); Ti and silicon (Si) and Ti5Si3; Zr and silicon, and Zr5Si3; niobium (Nb) and silicon, and Nb5Si3; Zr and Al , and ZrAl ; lead (Pb) and Al, and PbAl. Application of an energy source to the nano-layers in their initial state results in a self-propagating exothermic reaction and an intermetallic reaction product.

In operation, the application of an energy source to the nano-layers or thermal interface material of element 20 initiates a reaction that travels through the nano-layers creating a focused, localized heat source as the nano-layers exothermically convert into one or more of the above-identified reactants. The energy source can be the heat generated from a sustained current overload transmitted through the reactive material 20 or the fuse link 18. Alternatively, the energy source can be a spark, a flame, a heated filament, focused radio frequency (RF) radiation or light amplification by stimulated emission of radiation. Regardless of how the energy source is generated, the localized heating causes the reactive material 20 and/or the fuse link 18 to melt and open. Alternatively, the electrical fuse 10 can include or be in electrical communication with a monitoring or control circuit (not shown). The control circuit can periodically measure the electrical and mechanical characteristics associated with the fuse 10 such as the resistance, the current flow, temperature, etc., in order to establish an overall performance profile for the device. Moreover, the control circuit can be configured to provide an energy source and open the fuse link 18 in response to a degradation in the performance of the fuse 10, the occurrence of a predefined set of electrical or mechanical conditions, or any or desired criteria. It is also possible that the control circuit might be configured to monitor and respond to a condition external to the fuse and its immediate environment. For example, a crash sensor in a motor vehicle might be used to trigger an energy source to open one or more fuse links to disconnect electrical batteries. Regardless of how the energy source is produced, the opened connection within the electrical fuse 10 disrupts the flow of electrical current and prevents electrical communication along the circuit pathway 38 of the PCB 40 (see FIG. 1B).

The magnitude of the localized heating can also be controlled and focused to solder or braze and join components together in a highly controlled manner. Moreover, the intense focused heating in combination with the speed at which the reaction propagates allows dissimilar materials, such as metals and ceramics, to be joined despite the mismatch in each of the materials'coefficient of thermal expansion (CTE). In this way, dissimilar materials can be joined rapidly without have to compensate for the differences in their relative expansion rates.

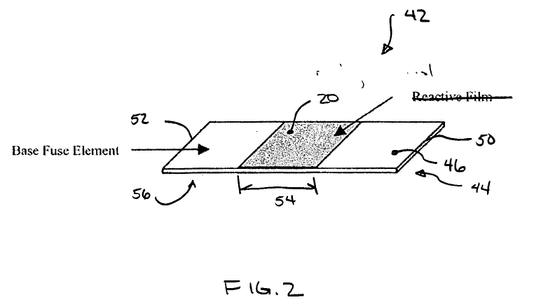

Returning to the drawings, FIGS. 2 to 12 show numerous physical embodiments of fuse elements and reactive materials, foils or elements cooperating to form a reactive fuse element or reactive fuse. Reactive fuse elements, or simply fuse elements, constructed in accordance with the teachings of these exemplary embodiments provide design flexibility that allows the fuse element to be selected to meet specific current surge and short circuit requirements unconstrained by the normal current overload considerations. In particular, the reactive fuse element can be designed to withstand brief current surges that would typically sever or open fuses that do not include the material or element because the current overload operating characteristics are determined by the composition of the reactive material and not necessarily by the fuse element alone. For example, the fuse link and reactive material can be selected and/or configured to open in response to different current conditions and loads thereby increasing the flexibility and utility of the fuse element. For instance, the material and physical properties of the fuse link can be established to accept a brief current spike that would typically open known fuse links. Conversely, the reactive material carried by the fuse link (see FIG. 1A) can be designed to open in response to a sustained current overload, e.g., where the current level remains higher than normal but does not spike, that has no effect on the fuse link. Stated another way, the heat generated by a sustained current load or overload provides enough energy input to activate the reactive material, while a brief current spike can be accepted by the fuse link because the heat generated by the spiked does not provide enough heat or energy input to activate the reactive material. In this way, a reactive fuse element can be designed, configured and specified that provides, for example, increased responsiveness to a sustained current overload and enhanced immunity to current spikes.

FIG. 2 illustrates one embodiment of a planar fuse element 42. The fuse element 42 includes an elongated fuse link 44 having a top surface 46 configured to carry the reactive material 20, which in this embodiment is a preform reactive film. The reactive material 20 may be bonded or joined to the top surface 46 using an adhesive such as for example an epoxy or an intermetallic bond formed at a bonding temperature less than the activation temperature of the reactive foil. For example, liquid SnPb solder can join the reactive material 20 to the top surface 26 of the fuse link 44 as long as the overall temperature of the liquid solder provides less energy input to the reactive material 20 than is required to start the self propagating reaction.

The reactive material 20 in the illustrated embodiment separates the first and second ends 50, 52 of the fuse link 44 to define a fusing area 54. The fusing area 54 defines the location along the elongated fuse link 44 where a sustained current overload will likely initiate the reaction of the reactive material 20 and physically sever or open the fuse link 44. It will be understood that the reactive material 20 could be sized to engage or cover the entire top surface of the fuse link 44 to provide a larger fusing area.

In a further alternative configuration the reactive film may be applied between the top surface 28 of the substrate 12 (see FIG. 1A) and a bottom surface 56 of the fuse link 44. That is, the conductive fuse link 44 overlies the reactive material 20 of, e.g., the above discussed nano-layers. In this way the localized heat produced by the reaction of the reactive material 20 in response to an energy input is focused on the insulative substrate 12 and the fuse link 44.

FIG. 3 illustrates one embodiment of a generally cylindrical element fuse 58. The element fuse 58 includes a fuse link 60 formed as a roughly cylindrical shell having a hollow interior 62 defined by open first and second ends 64, 66, respectively. The hollow interior 62 is sized to carry the reactive material 20 that may be a coiled reactive film, a contiguous piece of reactive material or simply reactive material layered and deposited through one of the first and second ends 64, 66 to partially, substantially or completely fill the cylindrical shell of the fuse element 60. In this way, electrical energy can pass through the fuse element 58 and fuse link 60 until enough energy is provided to activate the reactive material 20. Upon activation, the reactive material 20 generates an intense and localized heat to melt or vaporize the fuse link 60 and open circuit 38 (FIG. 1B) connected by the element fuse 58.

By securing the reactive material 20 within the fuse link 60, the energy generated by the self-propagating reaction is focused and directed onto the cylindrical shell. However, it will be understood that reactive material 20 could be wrapped around an external surface 70 of the fuse link 60 to open the fuse element 58 in response to the energy input. Moreover, the geometries of the fuse link 60 and the reactive material 20 could be modified to be, for example, rectilinear elements, octagonal elements, etc., without departing from the teachings of the disclosed embodiment. Although not illustrated, fuse 58 (and any fuse described herein) may include leads, terminals, contacts end caps or otherwise by configured to be mounted axially, radially, surface mounted, etc.

FIG. 4 illustrates another embodiment of a fuse element 72 that includes a generally cylindrical fuse link 74 carrying a spirally coiled reactive material 20 such as, for example, reactive wire about an external surface 78. In one embodiment, the reactive material 20 is a nano-layered wire consisting of a pair of reactants deposited in a plurality of coiled layers approximately 100 nm in thickness. The nano-layers initiate a self-propagating exothermic reaction to sever the fuse link 74 in response to an external energy input such as, for example, the heating of the cylindrical fuse element in response to a sustained current overload or triggered remotely by applying RF radiation from a transmitter. The magnitude of the exothermic reaction can be readily controlled based on the number of reactive material 20 windings around the external surface 78. Generally, an increase in the number of windings around the fuse link 74 results in a corresponding increase in the localized heat generated during the reaction of the reactive material 20.

Alternatively, the fuse link 74 could be a cylindrical wire that wraps or winds about a core of the reactive material 20 (see generally FIG. 3) or coiled wire of reactive material 20 (see generally FIG. 4). In this exemplary embodiment, the overload operating characteristics of the fuse element 72 could be modified by changing the number of windings of the fuse link 74 around the reactive material 20. Specifically, the cross-section of fuse link 74 can be increased which results in higher immunity to current surges, while increasing the number of windings raises the resistance of the element increasing self heating on an extended current overload condition.

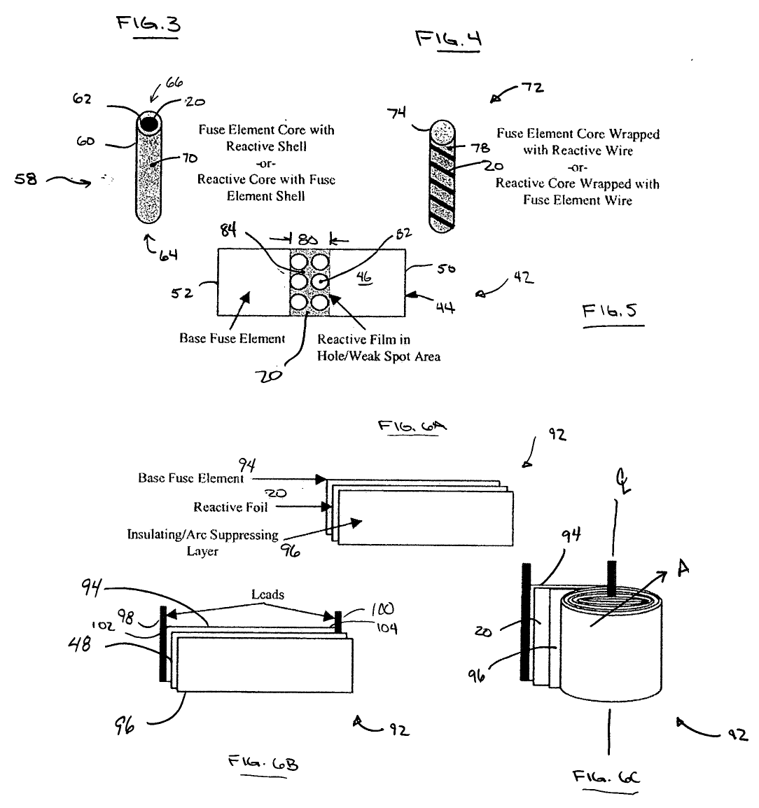

FIG. 5 illustrates an alternate embodiment of the reactive fuse element 42 (shown above in FIG. 2). In this exemplary embodiment the elongated fuse link 44 of the reactive fuse element 42 is arranged to carry the reactive material 20 between the first and second ends 50, 52. In particular, the reactive material 20 can include a plurality of voids or holes 82. The holes 82, in turn, define a number of high resistance bridges 84 arranged to open in response to sudden increases in current flowing though the fuse link 44. By changing the physical dimensions, i.e., length, width, thickness, etc., of the high resistance bridges 84 the sensitivity of the reactive material 20 to changes in electrical current, short circuits, etc., can adjusted.

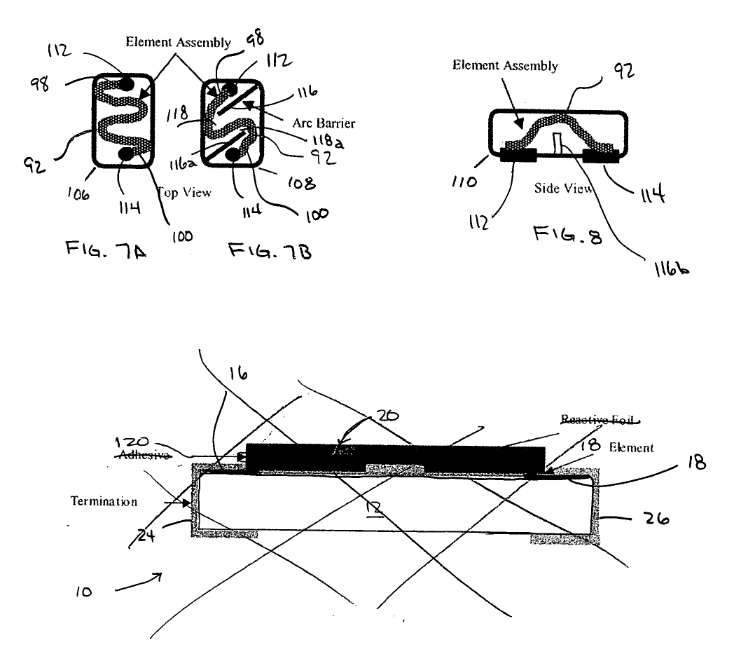

FIGS. 6A, 6B and 6C illustrate a layered and foldable reactive fuse 92 that can be constructed in accordance with the teachings of the present invention. The foldable reactive fuse 92 includes a flexible fuse link 94 aligned adjacent to a flexible layer of reactive material 20 and an insulating layer 96. Typically, the flexible fuse link 94 and the reactive material 20 will be precut and formed based on the size and power requirements of the application and/or the physical size of the circuit pathway 38 in which the foldable fuse 92 is to be employed. When assembled, the flexible fuse link 94 is positioned adjacent to and is electrically coupled to the reactive material 20. The insulating layer 96 abuts the two electrically coupled layers 94, 48. The insulating layer 96 prevents a short circuit between the electrically coupled layers 94, 48 along the direction indicated by the arrow A (as shown in FIG. 6C) when the layers 94, 48 and 96 are folded or wound about a central axis CL. To that end, insulating layer 96 may be slightly larger than link 94 and reactive material 20.

FIGS. 6B and 6C show first and second leads or terminals 98, 100 secured to corresponding first and second edges 102, 104 of the flexible fuse link 94. It will be understood that the first and second leads 98, 100 can be connected directly to the fuse link 94, flexible reactive material 20 or be indirectly to first and second edges 102, 104. Moreover, the leads 98, 100 could be tabs or projections integrally formed as a portion of the fuse layer 94 and/or reactive material 20. Similarly, the leads 98, 100 can be any electrically conductive wire that is bonded or otherwise electrically coupled to one or more of the fuse layer 94 and reactive material 20.

FIG. 6C shows the flexible layers 94, 20 and 96 wound about the central axis CL, however, it will be clear that the layers 94, 20 and 96 can be folded back-and-forth upon each other to have parallel folds that resemble an accordion bellows. If needed, a second insulative layer 96 may be coupled, e.g., via an adhesive, to link 94 to prevent a short across the fuse 92. The overall shape and size of the foldable reactive fuse 92 can be adjusted by modifying the length and thickness of the layers 94, 20 and 96 and the fold geometry, i.e., cylindrical or parallel folds.

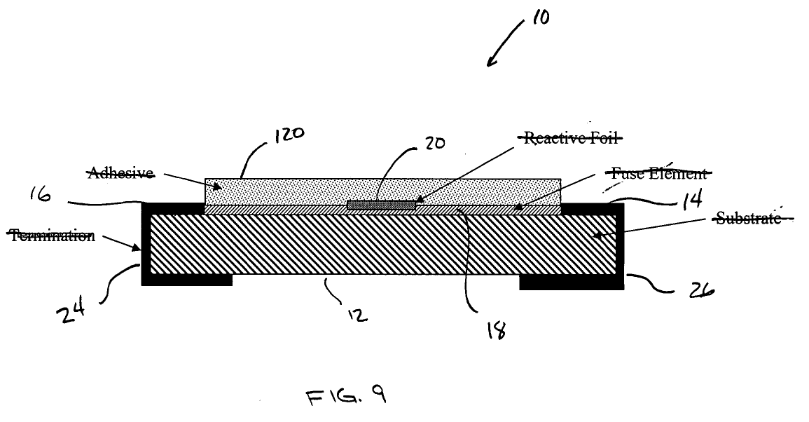

FIGS. 7A, 7B and 8 illustrate enclosures 106, 108 and 110, respectively, that can be used in conjunction with, for example, the foldable fuse 92 shown in FIGS. 6A to 6B. The enclosures 106, 108 and 110 enclose and seal the flexible fuse 92 to prevent fusing gases, liquids, etc., from escaping during and after the reaction of the reactive material 20 and opening of the corresponding fuse. The enclosures 106, 108, and 110 include contacts 112, 114 arranged to engage corresponding contact pads 112a, 114a formed as a part of the circuit pathway 38 (see FIG. 1B). The contacts 112, 114 cooperate with the leads 98, 100 of fuse 92 to electrically couple the foldable fuse 92 to the circuit pathway 38 and/or the PCB 40. The enclosure 108 includes a pair of arc barriers 116, 116a that engage the convolutions 118, 118a of the foldable fuse 92 to prevent arcing and short circuits upon opening of the foldable fuse 92. Similarly, the enclosure 110 includes an arc barrier 116b arranged to prevent undesirable arcing and short circuits between the folded ends of the fuse 92.

FIG. 9 illustrates another embodiment of the electrical fuse 10 shown in FIG. 1. In this configuration, the additional material such as an adhesive layer 120 is included to secure and protect the reactive material 20 in contact with the fuse 18 to ensure direct thermal coupling therebetween. In particular, a preformed piece of reactive material 20 can be placed adjacent to the fuse link 18 and affixed in position with an adhesive 120 such as a silicone resin. In addition, the adhesive 120 provides a regular surface suitable for cooperation with the vacuum nozzles of a pick and place machine. Alternatively, the reactive material 20 can replace the fuse link 18 and electrically couple the first and second termination pads 14, 16. In this embodiment, the reactive material 20 activates in response to a self-heating energy input caused by excessive current flow between the first and second termination pads 14, 16. The exemplary reactive material 20 could be formed into a variety of shapes such as, for example, straight or curled wires or planar strips as discussed above.

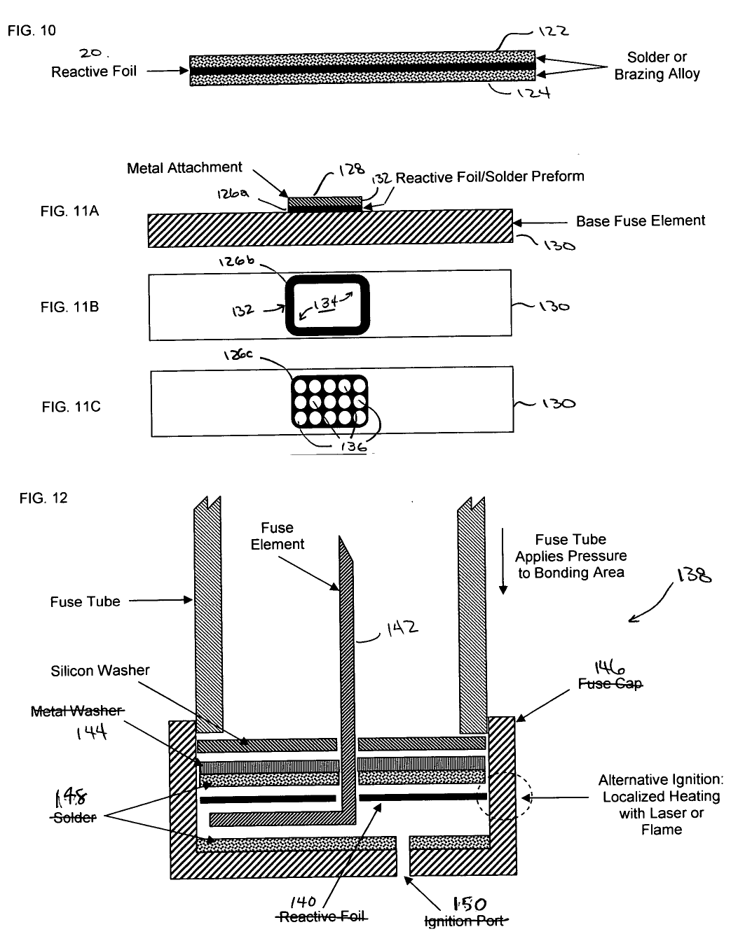

FIGS. 10, 11A, 11B, 11C and 12 illustrate additional embodiments that utilize the reactive material and/or reactive film or foils to provide localized heating for soldering, brazing or welding one or more metals together. FIG. 10 illustrates one embodiment of the reactive foil or material 20 positioned between a first and second metallic component 122, 124 to be joined. The first and second metallic components 122, 124 can be contact plates, mounting points, fuse elements or any other metallic, conductive or fusible component. This exemplary embodiment illustrates the reactive foil 48 sandwiched between the first and second components 122, 124, which could be a soldering or brazing preform. In operation, the reactive material 20 and the first and second components 122, 124 are held together under pressure to insure the alignment, and an energy source such as an electrical discharge, a spark, a laser pulse, a hot filament, or a flame initiated reaction within the reactive material 20. The resulting exothermic reaction creates heat sufficient to melt the solder or brazing alloy to metallurgically bond the first component 122 to the second component 124.

FIGS. 11A, 11B and 11C illustrate a preform reactive materials 126a, 126b and 126c that can be used to join a metal component 128 to a base fuse element 130. For example, the metal component 128 can be a tin (Sn) strip joined to a copper (Cu) fuse element to serve as an “M” spot to take advantage of the Metcalf Effect by lowering the overall melting temperature of the resulting SnCu alloy. For large fuses, the localized heat source provided by the reactive materials 126a, 126b and 126c eliminates the need to raise the overall temperature of the entire fuse mass/component to the joining temperature of the Sn strip and Cu fuse element. As shown in FIG. 11A, the preform reactive material 126a is positioned between the base fuse element 130 and the metal component 128 to be attached. FIG. 11B illustrates the preform reactive material 126b arranged to facilitate diffusion of the metal component 128 into the base fuse element 130 only along a perimeter 132 of the component 128 thereby leaving an inner area 134 free of the intermetallic reactant products formed by the cooperation of the nanolayers of initial reactants that comprise the reactive material 126a, 126b and 126c. FIG. 11C illustrates the perform reactive material 126c having a plurality of voids 136 arranged to control and reduce the intensity of localized heat produced by the reaction initial reactants.

FIG. 12 illustrates a cartridge fuse 138 that includes a reactive foil 140 arranged to provide a source of heat for joining the fuse element 142, a conductive washer 144 and a fuse cap 146. In particular, the washer 144 and fuse element 142 can be coated with a solder layer or brazing alloy 148 and be positioned adjacent to the reactive foil 140. An energy source such as a spark can be applied through an ignition port 150 to initiate the reaction within the reactive element 140. The heat generated as a result of the reaction will typically melt the solder layer 148 which, in turn, flows and metallically connects the washer 144 and fuse element 142. The metallic connection serves to electrically connect the fuse cap 146 to the fuse element 142 and a corresponding fuse cap to the element, not shown, at the opposite or distal end of the cartridge fuse 138. Although FIG. 12 shows a specific fuse design, the reactive foil and the perform concepts are applicable to various types of fuse constructions, as well as the attachment of a fuse to a circuit substrate.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A reactive fuse comprising:
a substrate having a top surface, the substrate further including a first end and a second end arranged distal to the first end;
a first conductor positioned adjacent to the first end along the top surface;
a second conductor positioned adjacent to second end along the top surface, the first and second conductors spaced apart along the top surface; and
a reactive material cooperating with the substrate to electrically couple the first and second conductors, the reactive material having a stable state and a exothermic state.

2. The reactive fuse of claim 1, wherein the substrate is an insulative substrate manufactured from the material selected from the group consisting of:
flame retardant woven glass reinforced epoxy laminates, non-woven glass laminates, ceramics, glass, polytetrafluoroethylene, microfiber glass substrates, thermoset plastics, polyimide materials, or any combination of these materials or other suitable materials.

3. The reactive fuse of claim 1, wherein the reactive material is configured to produce a self-propagating exothermic reaction in response to an energy input.

4. The reactive fuse of claim 3, wherein the energy input is selected from the group consisting of:
a current overload, a spark, a flame, a heated filament, focused radio frequency radiation or light amplification by stimulated emission of radiation.

5. The reactive fuse of claim 1, wherein the reactive material is a nano-layered material.

6. The reactive fuse of claim 5, wherein the nano-layed material is constructed of alternating layers of nickel and aluminum.

7. The reactive fuse of claim 1 further comprising a fuse link positioned adjacent to the substrate and the reactive material, wherein the fuse link is electrically coupled to the first and second conductors.

8. The reactive fuse of claim 7, wherein reactive material converts from the stable state to the reactive state in response to an energy input to sever the fuse element.

9. The reactive fuse of claim 8, wherein the energy input is selected from the group consisting of:
a current overload, a spark, a flame, a heated filament, focused radio frequency radiation or light amplification by stimulated emission of radiation.

10. The reactive fuse of claim 1, wherein the reactive material is a reactive foil aligned adjacent to the substrate, and the substrate is a flexible insulative substrate such that the reactive foil and the flexible insulative substrate are bendable to align the first and second conductors in an overlapping arrangement.

11. A fuse element for use in a reactive fuse, the fuse element comprising:
a fuse link; and
a reactive material carried by the fuse link, the reactive material having a plurality of nano-layers configured to produce a self-propagating exothermic reaction in response to an energy input.

12. The fuse element of claim 11, wherein reactive material is constructed of a material selected from the group consisting of a plurality of alternating layers of nickel and aluminum; titanium and boron; zirconium and boron; hafnium and boron; titanium and carbon; zirconium and carbon; hafnium and carbon; titanium and silicon; zirconium and silicon; niobium and silicon; zirconium and aluminum;
lead and aluminum.

13. The fuse element of claim 11, wherein the fuse link is a cylindrical fuse link.

14. The fuse element of claim 13, wherein the fuse link includes an exterior surface, the exterior surface arranged to carry the reactive material.

15. The fuse element of claim 14, wherein the reactive material spirally engages the exterior surface of the fuse link.

16. The fuse element of claim 11, wherein fuse link includes first and second ends spaced apart by the reactive material to define a fusing area.

17. A method of forming a fuse element comprising:
providing an electrically conductive fuse link having a bonding surface;
aligning a reactive material adjacent to the bonding surface of the fuse link, , the reactive material having a plurality of nanolayers configured to produce a self-propagating exothermic reaction in response to an energy input
establishing a fusing area, the fusing area defined between the reactive material and the fuse link; and
securing the reactive material to bonding surface to define a reactive fuse element.

18. The method of claim 17, wherein the electrically conductive fuse link is a cylindrical fuse link having a hollow interior.

19. The method of claim 18, wherein the reactive material is carried within the hollow interior of the fuse link.

20. The method of claim 17, wherein the fusing area encompasses a first end of the fuse link and a second end of the fuse link, the second end of the fuse link formed distal to the first end.

21. The method of claim 17, wherein the reactive material is secured using a silicone cover affixed adjacent to the bonding surface.

22. The method of claim 17, wherein the reactive material is secured using an adhesive positioned between the fuse link and the reactive material.
